(19) United States
(12) Patent Application Publication
(10) Pub. No.: US 2013/0276364 A1
(43) Pub. Date: Oct. 24, 2013

(54) Artificial Ice

(71) Applicant: Phillip Gerard LANGHORST, St. Louis, MO (US)

(72) Inventor: Phillip Gerard LANGHORST, St. Louis, MO (US)

(73) Assignee: INVENTION HOUSE, LLC, St. Louis, MO (US)

(21) Appl. No.: 13/778,316

(22) Filed: Feb. 27, 2013

Related U.S. Application Data
(60) Provisional application No. 61/604,297, filed on Apr. 3, 2012.

(51) Int. Cl. A01G 33/00; G02B 5/124; G02B 5/08

(52) U.S. Cl. CPC A01G 33/00; G02B 5/08; G02B 5/124
USPC 47/1.4; 359/838

(57) ABSTRACT

The invention provides an artificial ice substrate that floats on a body of water. The top surface of the artificial ice reflects a portion of the sunlight back away from the earth. The bottom surface has nutrients for enhancing the growth of algae. Several weeks after placement of the artificial ice in the body of water, a ship with harvesting equipment, scrapes the algae off artificial ice and into a collection tank, re-applies nutrients to the underside of the ice substrate, and then deposits the artificial ice back into the lake or ocean. The marine plants are then converter into fuel. Besides creating carbon neutral fuel, this method provides carbon credits by means of reflecting sun energy back into space.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### FIELD OF THE INVENTION

This invention relates to system for lowering planetary temperature and reducing atmospheric CO₂, and, more specifically, a system that provides a reflective structural foundation for algae growth and various methods for harvesting algae.

### BACKGROUND OF THE INVENTION

The polar ice caps of the planet earth reflect sunlight. This prevents solar energy from being absorbed by the earth's oceans. With the more recent shrinking of ice cap surface area, the amount of solar energy reflected away from the earth has lessened, and the amount of solar energy absorbed by the earth's ocean has increased, contributing to global warming.

Algae growing in the sea are being used as a raw material to produce fuel. The algae absorb carbon dioxide, and releases oxygen. When algae die, it decomposes. The decomposition process gives off carbon dioxide. If algae are harvested/processed before it has a chance to decompose naturally, and then the algae are used as a fuel, this offsets carbon dioxide that would have been produced by burning fossil fuels.

### SUMMARY OF THE INVENTION

The invention is a system for lowering planetary temperature and reducing atmospheric CO₂, using novel artificial ice. The invention provides an artificial ice substrate deposited on a body of water such as a lake or ocean. The top surface of the artificial ice reflects a portion of the sunlight back away from the earth. The bottom surface has nutrients for enhancing the growth of algae. Several weeks after placement in the body of water, a ship pulls the artificial ice substrate onboard, scrapes the algae off into a collection tank, re-applies nutrients to the underside of the ice substrate, and then deposits the artificial ice back into the lake or ocean.

In an alternate embodiment, to handle a harvesting surface area that is wider than a ship, an alternated ship construction with multiple floating booms and collection trays, and an end tug is provided. The booms with collection trays are extended from the ship, the artificial ice is pulled over the extended booms while the algae are collected. Then nutrients are re-applied and the artificial ice is deposited back into the lake or ocean.

In another embodiment, the ship harvests by rendering the entire artificial ice structure, including attached marine plants.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view of an embodiment of the system of present invention where the artificial ice is shown in the form of floating sheets.

FIG. 2 is a perspective view of a first alternate embodiment of the artificial ice in the system of the present invention.

FIG. 3 is a perspective view of a second alternate embodiment of the artificial ice in the system of the present invention.

FIG. 4 is a schematic view of the preferred embodiment of the system of the present invention wherein a ship processes the entire artificial ice structure including marine plants.

FIG. 5 is a top view of a first alternate ship embodiment wherein a ship in transit is towing a floating harvesting boom in the system of the present invention.

FIG. 6 is a top view of the embodiment of FIG. 5, wherein the ship has deployed the boom into the working position.

FIG. 7 is a side view and partial cutaway view of a ship harvesting algae from the artificial ice, re-applying nutrients, and re-placing the artificial ice into the water.

FIG. 8 is a schematic diagram of prior art showing a pyrolysis method for converting plant material into fuel.

### DETAILED DESCRIPTION OF THE INVENTION

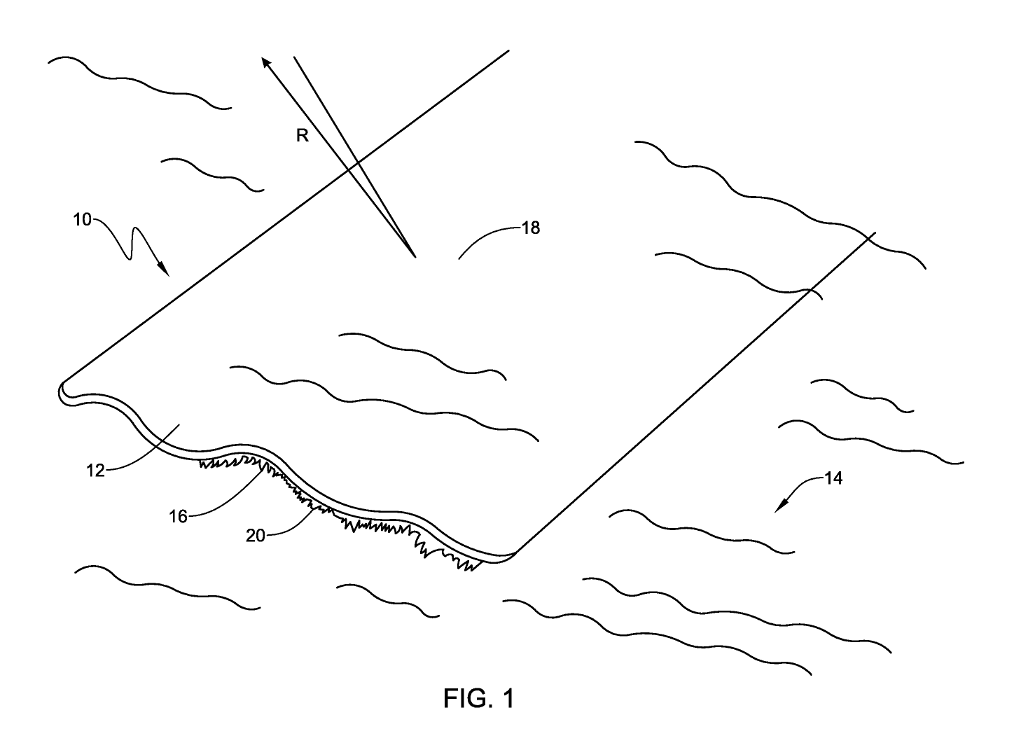

FIG. 1 shows artificial ice, shown generally at 10, according to the system of the present invention, in the form of floating sheets 12 floating on a body of water 14 such as a lake or ocean. The artificial ice 10 reflects solar light rays back to space. Also shown are marine plants 16, such as algae, thriving on the underside of the floating sheet 12 and absorbing CO₂. The artificial ice 10 has a top surface 18 that partially reflects, shown generally at R, sunlight.

The light-reflecting top surface 18 can be specifically designed to reflect the most harmful spectra. The light-reflecting top surface 18 preferably has a 3-corner “retro reflector” surface to cause solar light rays to reflect back towards the sun. The 3-corner retro reflector surface can shorten the distance back out to space even where the wave action of the body of water 14 changes the angle of the floating sheet 12. (It is noted that automobile tail lights and street signs use a 3-corner retro reflector surface.)

The bottom surface of floating sheet 12 can be provided with a layer of plant nutrients or fertilizer 20. The layer of plant nutrients or fertilizer 20 is preferably of the time-release variety. The floating sheet 12 and the fertilizer layer 20 are preferably specifically translucent at certain light frequencies to allow these specific light frequencies to reach the marine plants 16.

The floating sheet 12 can be constructed from sheets of organic material such as straw, corn stalks, corn cobs, bamboo, bagasse, etc. Fibers from the sheet can present a non-uniform bottom surface texture to form fiber protrusions that provide more surface area for marine plants, such as algae and plant plankton. In an alternate embodiment, the floating sheet 12 could be a layer of oil (preferably vegetable oil) which has reflecting pigment or the retro-reflecting particles infused within it.

Therefore, the artificial ice 10 reduces global warming in two ways—first by reflecting some sunlight away from the earth, and second by growing marine plants that absorb the greenhouse gas CO₂.

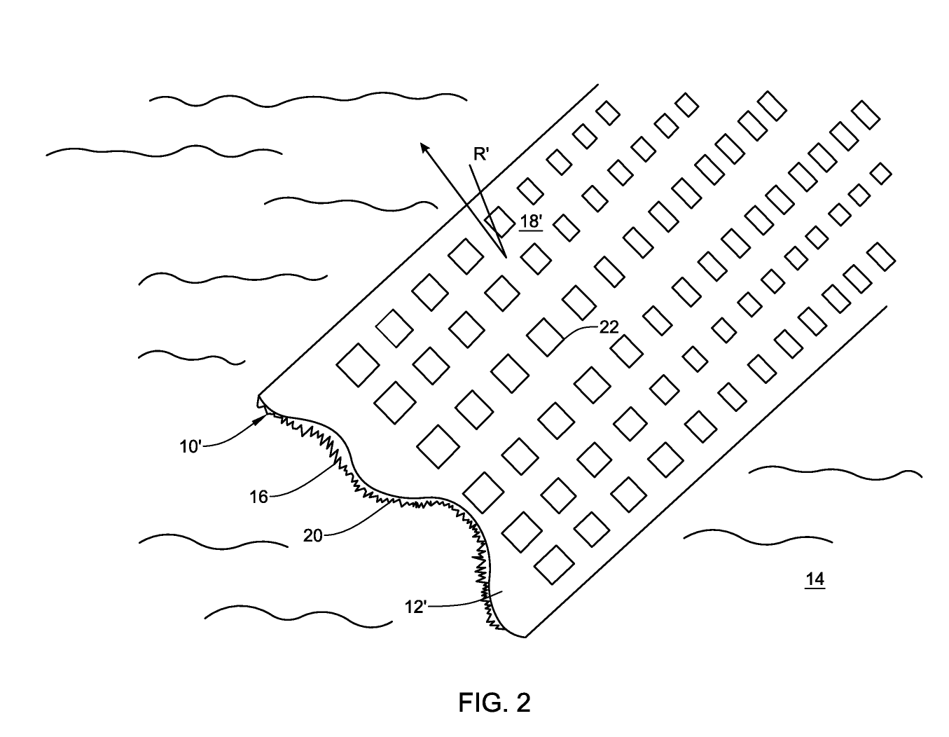

In a first alternate preferred embodiment as shown in FIG. 2, an alternate construction for artificial ice 10′ differs from that of artificial 10 in FIG. 1 in that floating sheet 12′ is provided with a number of apertures 22. These apertures 22 allow light to pass through and allow a greater opportunity for marine plants 16 to receive light. Because the apertures allow unfiltered light to pass, it is possible to alter the reflectance characteristics of top surface 18′ to provide a higher reflectance (and less translucence of specific frequencies) as compared with the reflectance characteristics of top surface 18 of FIG. 1.

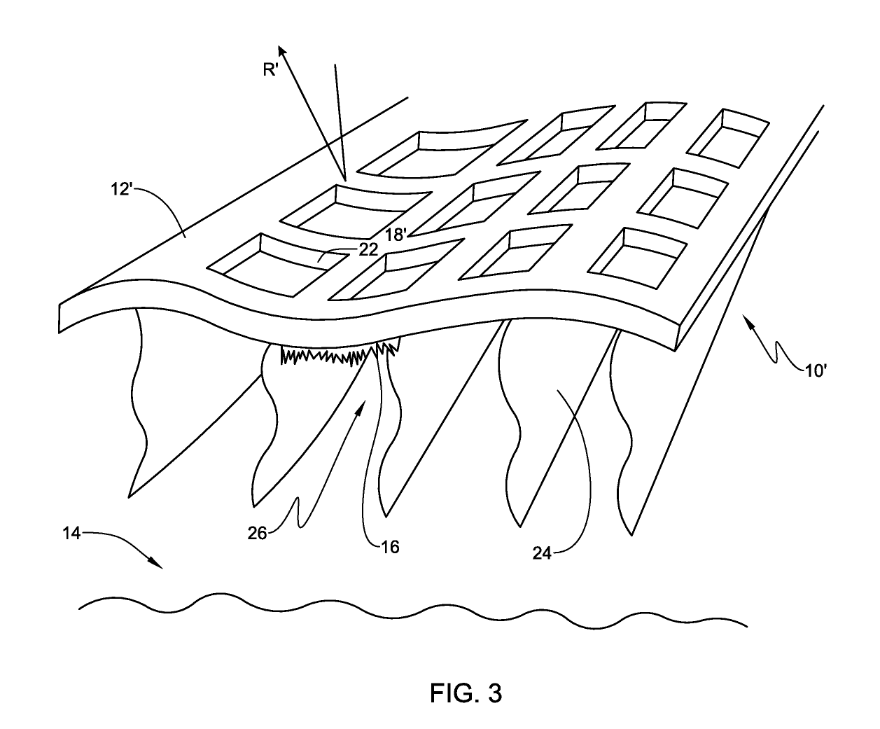

In a second alternate preferred embodiment, FIG. 3, the floating sheet 12′ of FIG. 2 is further provided with a series of dividers 24 that define a series of spaces 26. Dividers 24 help to arrest the flow of water, and thus help to arrest the flow of plant life. In other words, dividers 24 help to secure marine plants 16 to floating sheet 10′.

In the system of the present invention, marine plants 16 must be harvested before significant decomposition. If harvested before decomposition, then at the point of harvest, the marine plants 16 have absorbed CO₂, released oxygen, and have provided a net carbon reduction benefit in the effort to reduce greenhouse gases.

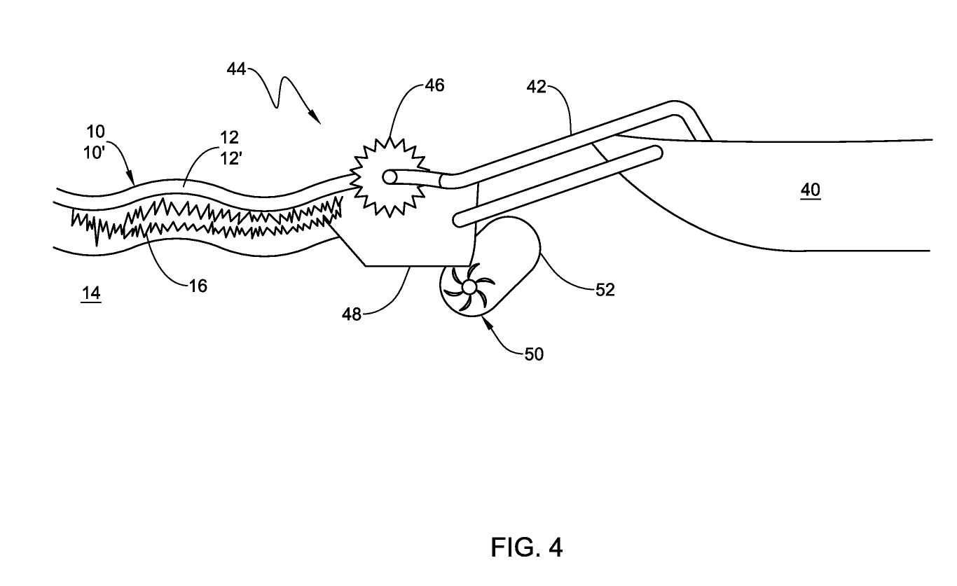

Therefore, as to harvesting marine plants 16, the system of the present invention provides a large ship 40 that processes artificial ice 10, 10′. As shown in FIG. 4, a ship 40 extends arms 42 to support a harvesting apparatus, shown generally at 44. Harvesting apparatus 44 both pulls and renders artificial ice 10, 10′, including attached marine plants 16, via grinding cutter 46. It is noted that a pulling wheel (not shown) may be employed separately from grinding cutter 46, or the pulling wheel function may be incorporated into a single grinding cutter 46 device. After rendering, the rendered product drops into collection tank 48. From there, pump 50 pumps the rendered product via pipe 52 to a larger collection tank (not shown).

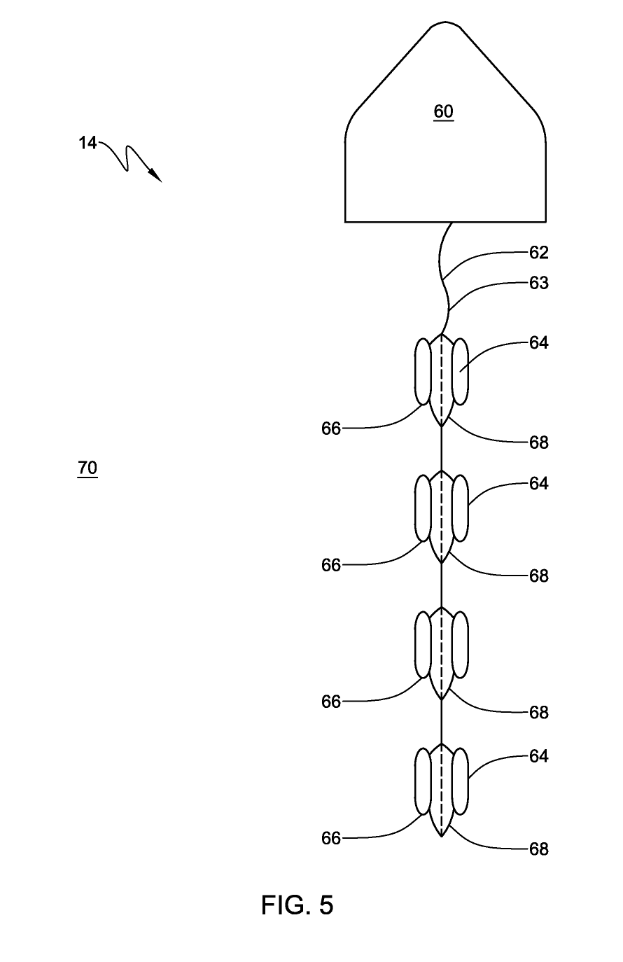

FIGS. 5-8 illustrate a first alternate ship embodiment of the system of the present invention. In this first alternate ship embodiment, marine plants 16 are harvested, while artificial ice 10, 10′ is re-provisioned with nutrients or fertilizer 20, and then re-deployed into the body of water 14. As shown in FIG. 2, a ship 60 in transit is towing a floating harvesting boom apparatus, shown generally at 70. Floating harvesting boom apparatus 70 is equipped with a tow cable 62 in parallel with pipes 63 that are in turn each connected to multiple supporting pontoons 64. Each supporting pontoon 64 is provided with harvesting wheels 66, and a collection trough 68.

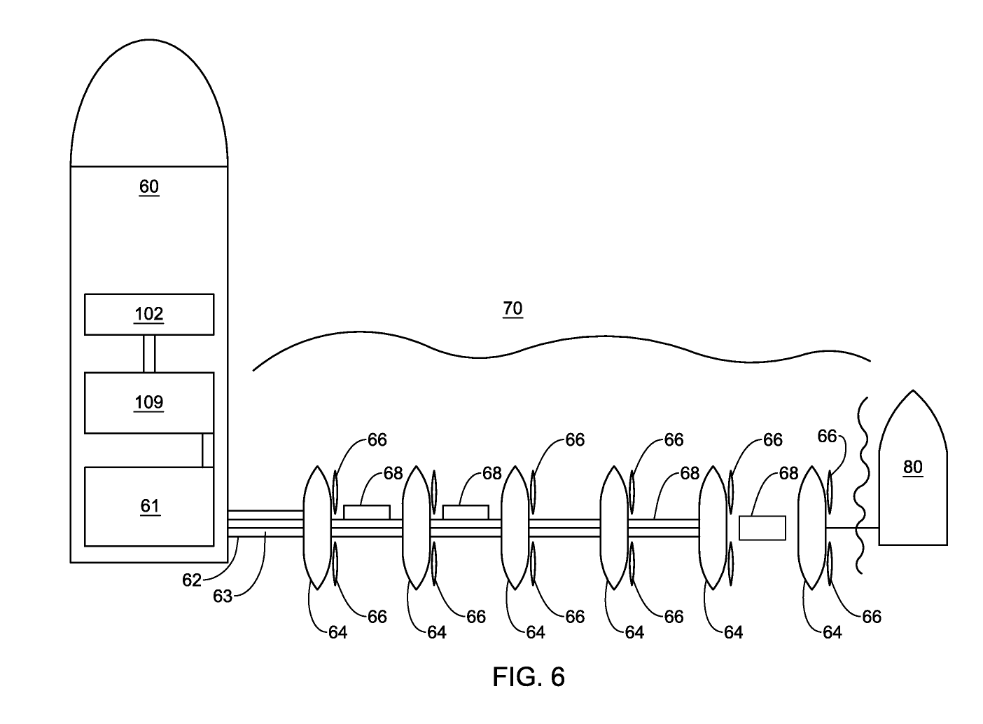

As shown in FIG. 6, wherein the ship 60 has deployed the harvesting boom apparatus 70 into the working position. Each pontoon 64 supports a pair of harvesting wheels 66 and a collection trough 68.

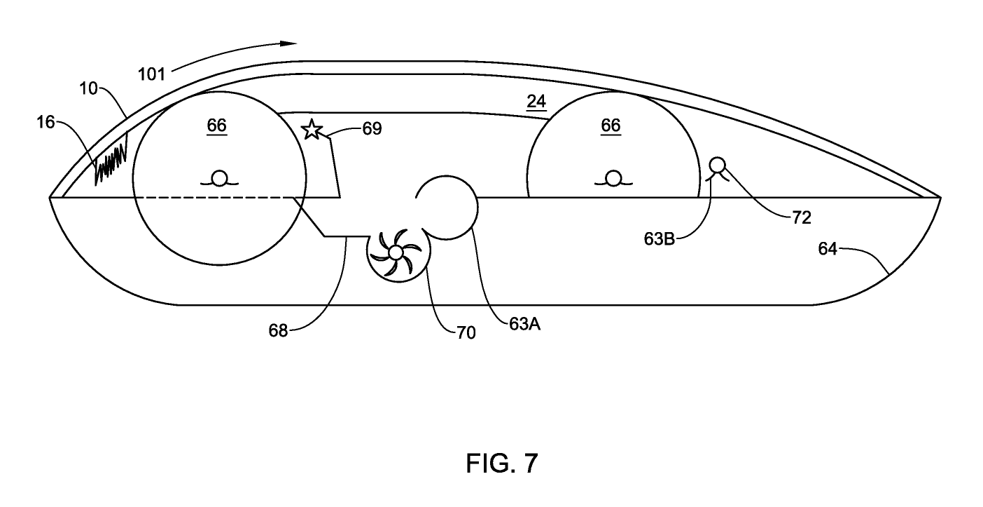

As shown at the left side of FIG. 7, artificial ice 10, 10′ is lifted by harvesting wheel 66 which pulls floating sheet 12, 12′, while scraper 69 (alternately referred to as cutting wheel 69) separates marine plants 16 from floating sheet 12, 12′, and renders the marine plants 16. The marine plants 16 drop into collection trough 68. Pump 70 pushes the rendered material through Pipe 63A to main collection tank 61 of ship 60.

Now largely free of marine plants 16, floating sheet 12, 12′ is further pulled by the second harvesting wheel 66 and deposited back into the body of water 14. Just before floating sheet 12, 12′ is re-deposited, pipe 63B delivers a liquid fertilizer layer 20 through sprayer 72. The fertilizer layer 20 may be sprayed onto the bottom surface of floating sheet 12, 12′, or the fertilizer layer 20 may be sprayed onto surface of the body of water 14 just as floating sheet 12, 12′ enters the water. Either way, fertilizer layer 20 is captured by floating sheet 12, 12′. It should be understood that if the embodiment of FIG. 3 is used, the dividers 24 help retain the liquid fertilizer under floating sheet 12, 12′.

Floating boom 70 can be extended in length to match the appropriate dimension of the artificial ice 10, 10′ by adding additional pontoon units. In this regard, for those floating booms 70 that are very long, to assist in control and to avoid pipe breakage, an additional tug boat 80 (FIG. 6) may be employed at the end to enhance stability and control.

After ship 60 has collected rendered marine plant 16 material, ship 60, which is preferably a factory ship, processes the marine plant material 16. In other words, the marine plant material can be processed into fuel that can be stored in the ship 60. Specifically, the marine plant material 16 is converted to fuel using one of several methods including but not limited too: thermal decomposition using pyrolysis or gasification followed by condensation, fermentation followed by distillation, or enzymatic reduction. Pyrolysis is one of the preferred methods because it is fast, efficient and yields mostly a liquid fuel product. There are several known pyrolysis techniques. Thus, marine plant material in collection tank 61 is transferred via pipe to pyrolysis processing 109. The resulting fuel is transferred via pipe to fuel tank 102.

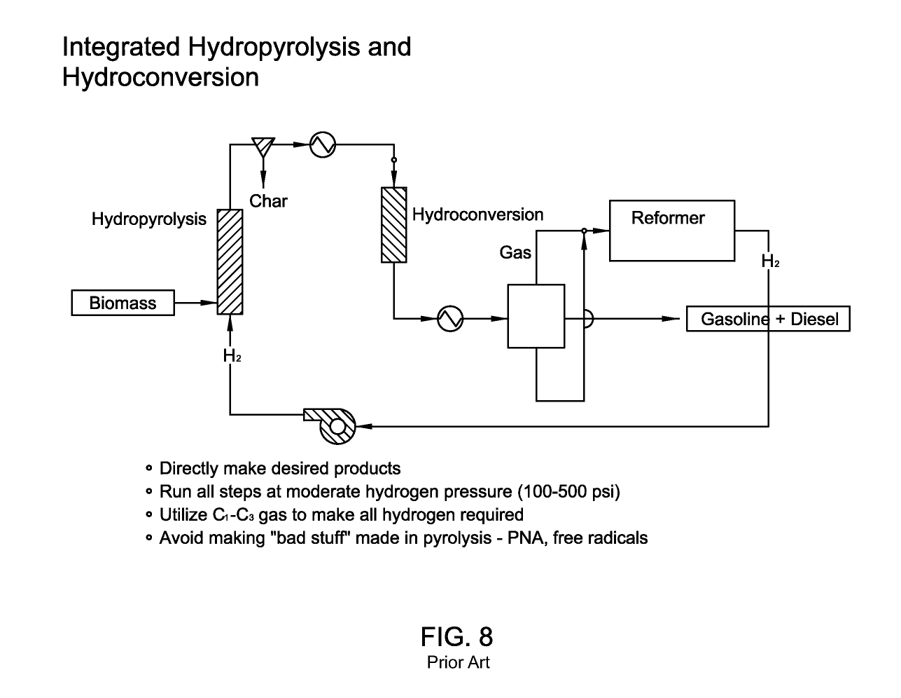

It should be noted that most pyrolysis processes produce biomass oil, which in the present invention would be delivered by the ship at port. The biomass oil undergoes a second and further conversion to diesel oil. However, it should be noted that it is also possible to bypass the use of two separate conversion processes by using a single process: see prior art shown in FIG. 8. If this process is used in pyrolysis processing (FIG. 8), the resulting fuel is delivered via pipe to fuel tank labeled “gasoline+diesel” (FIG. 8).

The artificial ice 10, 10′ are preferably hundreds of feet wide and miles long. Additional tugs (not shown) can be used for towing the artificial ice 10, 10′ away from the floating boom 70.

Alternatively, the ship 60 can re-configure the floating boom 70 to consume the entire artificial ice sheet 10, 10′ in addition to the marine plants 16, according to the process shown and described in FIG. 4.

It should be noted that small solar powered boats (not shown) may be utilized to help maintain the position of artificial ice 10, 10′. Specifically, a solar powered boat may be connected by tow cable to artificial ice 10, 10′, at each of several corners. Each solar powered boat operates automatically to maintain a pre-selected GPS coordinate, making adjustments in position as circumstances require. This allows the artificial ice 10, 10′ to maintain a relatively fixed location for later harvesting. Alternately, several redundant transmitters may be attached to each artificial ice 10, 10′ section to transmit GPS coordinate location on a specified frequency to allow later harvesting.

Besides fuel, there is another means, referred to as Carbon Credits, to derive benefit from the process described above. A Carbon Credit is a device which allows companies who exhaust excessive carbon into the atmosphere to offset their carbon by paying other companies who have the means to absorb carbon from the atmosphere. The “credit” is actually a paper representation of a specific amount of carbon, (or other greenhouse gas) which has been sunk or offset. The process described above can produce carbon credits in two ways. A) The reflective surface of floating sheet 12 (FIG. 1), will send some portion of the sun's energy back into outerspace. The portion sent back into space will not contribute to planetary warming. This will be as effective as removing greenhouse gasses from the atmosphere. The amount of energy sent back into space will qualify for an equivalent amount of carbon credit. B) The marine plants grown, 16 (FIG. 1) can be sequestered. “Sequestered” in this sense means to store or bury the material so that its carbon cannot return to the atmosphere. The marine material could be pumped into abandoned mines or pumped in to deep stagnant areas of the ocean where they will not release their carbon. Over time ground buried plants will evolve methane gas which could be burned on site to produce electricity. Producing electricity in this manor would negate part of the carbon credit but is still preferable to burning other fossil fuel because it would have fewer other pollutants such as sulphur.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A fuel produced from a method comprising:
a floating sheet, said floating sheet floatable on a body of water and having a bottom surface adapted to the growth of marine plants;
said marine plants removed from said body of water;
said marine plants converted into fuel via conversion process.

2. The method of claim 1, wherein said floating sheet further comprises a plurality of apertures for allowing light to pass through.

3. The method of claim 1, wherein said floating sheet further comprises a plurality of dividers spaced apart and connected to the bottom of said floating sheet.

4. The method of claim 1, wherein said conversion process comprises one of the following;
thermal decomposition using pyrolysis, gasification followed by condensation, fermentation followed by distillation, or enzymatic reduction.

5. The method of claim 1, wherein said floating sheet is comprised of an oil.

6. A carbon credit produced from a method comprising:
a floating sheet, said floating sheet floatable on a body of water and having a bottom surface adapted to the growth of marine plants;
said marine plants place out of earth's atmosphere via sequestering means.

7. The method of claim 6, wherein said sequestering mean are comprised of one of the following; ground burial, or deep water submergence.

8. The method of claim 6, wherein said floating sheet further comprises a plurality of apertures for allowing light to pass through.

9. The method of claim 6, wherein said floating sheet further comprises a plurality of dividers spaced apart and connected to the bottom of said floating sheet.

10. A carbon credit produced from a method comprising:
a floating sheet, said floating sheet floatable on a body of water and having a top surface, said top surface having a reflective element for reflecting a portion of light incident upon it.

11. The method of claim 10, wherein said reflective element comprises 3-corner retro reflectors.

12. The method of claim 10, wherein said floating sheet is comprised of an oil.
